(19) United States
(12) Patent Application Publication
(10) Pub. No.: US 2022/0305730 A1
(43) Pub. Date: Sep. 29, 2022

(54) Improved Stereolithography System

(71) Applicant: FORCAST RESEARCH & DEVELOPMENT CORP., Prince George (CA)

(72) Inventor: Gabriel Rodrigo CASTANON DELGADO, Prince George (CA)

(21) Appl. No.: 17/608,014

(22) PCT Filed: May 7, 2020
(86) PCT No.: PCT/CA2020/050621

§ 371 Date: Nov. 1, 2021

Related U.S. Application Data
(60) Provisional application No. 62/845,226, filed on May 8, 2019.
(60) Provisional application No. 62/871,661, filed on Jul. 8, 2019.

(51) Int. Cl. B29C 64/255; B33Y 30/00; B29C 64/295

(52) U.S. Cl. CPC B29C 64/255; B33Y 30/00; B29C 64/295

(57) ABSTRACT

A stereolithography system comprises an emitting device and a tank above the emitting device. The tank has an optically transparent bottom wall. There is a linear stage extending away from the tank and a carrier platform moveable along the linear stage and a membrane within the tank. The membrane has a first surface and a second surface. The membrane and the optically transparent bottom wall of the tank define a chamber which contains a fluid. The membrane sits atop the fluid and resin sits atop the membrane. The fluid holds the weight of the membrane and the resin, and provides the membrane with a substantially flat printing surface while allowing the membrane to flex. The fluid may be a liquid, a semi-solid gel, or a substance having a consistency therebetween. The membrane may be a composite membrane made of different materials on the first surface and the second surface thereof.

### TECHNICAL FIELD

The present disclosure relates to a stereolithography system and, in particular, to a stereolithography system including a tank having a membrane separating a fluid and a resin in the tank.

### BACKGROUND

U.S. Pat. No. 5,122,441, which issued on Jun. 16, 1992 to Lawton et al., discloses an apparatus and method for fabricating integral three-dimensional objects from successive layers of photoformable compositions by exposing the layers of the composition through a semi-permeable film that allows creation of release coatings on the side of said film facing said composition. Examples of such semi-permeable films may be composed of polypropylene (such as, for example, film manufactured by Hercules Inc. Wilmington Del.), Teflon PFA®, Teflon PTFE® (such as, for example, manufactured by E. I. DuPont De Nemours Inc., Wilmington Del.), or polyethylene, etc. or any of a number of polymer and copolymer films.

### SUMMARY OF THE DISCLOSURE

There is provided a stereolithography system comprising an emitting device and a tank disposed above the emitting device. The tank has an optically transparent bottom wall. There is a linear stage extending away from the tank and a carrier platform moveable along the linear stage. There is a membrane disposed within the tank. The membrane has a first surface and a second surface. The membrane and the optically transparent bottom wall of the tank define a chamber which contains a fluid. The membrane sits atop the fluid and resin sits atop the membrane. The fluid holds the weight of the membrane and the resin, and provides the membrane with a substantially flat printing surface while allowing the membrane to flex.

The membrane may include a fluorinated ethylene propylene or a polytetrafluoroethylene. The membrane may be a composite membrane made of different materials on the first surface and the second surface thereof. The first surface may include a silicone-based polymer, such as polydimethylsiloxane, or a polyolefin polymer such as polyethylene or polypropylene. The fluid may be a liquid, a semi-solid gel, or a substance having a consistency therebetween. The fluid may be denser than the resin and may be immiscible with water. There may be a heat exchanger to heat and/or cool the fluid. There may be a pump/reservoir combination in fluid communication with the chamber.

There is also provided a stereolithography system comprising an emitting device and a tank disposed above the emitting device. The tank has an optically transparent bottom wall. There is a linear stage extending away from the tank and a carrier platform moveable along the linear stage. There is a gas permeable membrane disposed within the tank. The gas permeable membrane has a first surface and a second surface. The gas permeable membrane and the optically transparent bottom wall of the tank define a chamber which contains an oxygenated fluid. Oxygen from the oxygenated fluid permeates from the first surface of the gas permeable membrane to the second surface of the gas permeable membrane. The oxygen inhibits curing of resin on the second surface of the gas permeable membrane.

The gas permeable membrane may be a fluoroplastic membrane such as a Telfon® AF 2400 film. The gas permeable membrane may be a composite membrane made of different materials on the first surface and the second surface thereof. The first surface may include a silicone-based polymer, such as polydimethylsiloxane, or a polyolefin polymer such as polyethylene or polypropylene. The oxygenated fluid may be a liquid, a semi-solid gel, or a substance having a consistency therebetween. The oxygenated fluid may include propylene glycol, silicone oil, mineral oil or paraffin oil. The oxygenated fluid may include an oxidizing agent. There may be a heat exchanger to heat and/or cool the oxygenated fluid. There may be a pump/reservoir combination in fluid communication with the chamber.

### BRIEF DESCRIPTIONS OF DRAWINGS

FIG. 1 is a perspective view of a first embodiment of an improved stereolithography system;

FIG. 2 is a front elevational, partially broken away view of the stereolithography system of FIG. 1;

FIG. 3 is a schematic cross-sectional view of the tank of the stereolithography system of FIGS. 1 and 2;

FIG. 4 is a perspective, sectional view of the tank and a carrier platform of the stereolithography system of FIG. 1;

FIG. 5 is a front elevational, partially broken away view of a second embodiment of an improved stereolithography system;

FIG. 6 is a perspective, sectional view of a tank and a carrier platform of the stereolithography system of FIG. 5;

FIG. 7 is a front elevational, partially broken away view of a third embodiment of an improved stereolithography system; and

FIG. 8 is a perspective, sectional view of a tank and a carrier platform of the stereolithography system of FIG. 7.

### DESCRIPTIONS OF SPECIFIC EMBODIMENTS

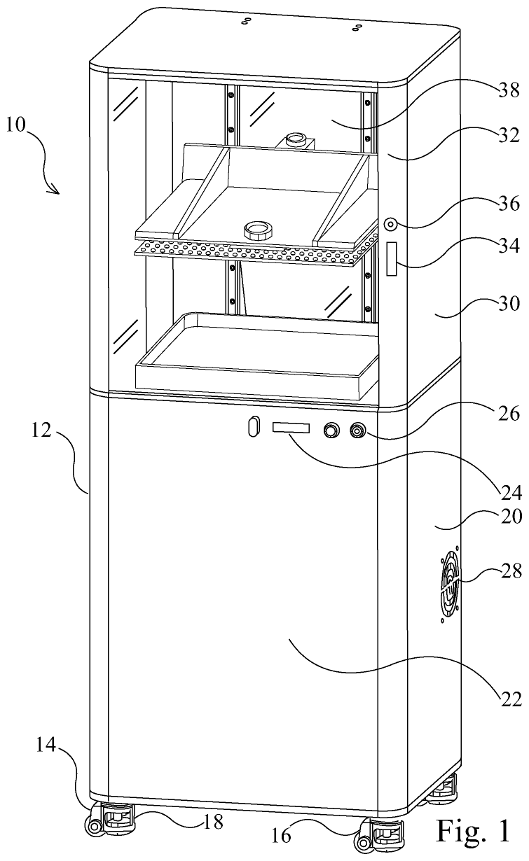

Referring to the drawings and first to FIG. 1, there is shown a first embodiment of an improved stereolithography system 10. The stereolithography system 10 comprises a housing 12 which is mounted on a plurality of castors, for example, castors 14 and 16, to allow the stereolithography system 10 to be easily moved to a desired location. The castors 14 and 16 are substantially identical in structure and function and each has a respective brake, for example, brake 18 which is called out for one of the castors 14. The brake 18 is a ground engaging brake and allows the stereolithography system 10 to be fixed at the desired location. The housing 12 has a lower portion 20 and an upper portion 30. The lower portion 20 of the housing 12 includes a door 22 provided with a handle 24 and a lock 26 to allow and restrict access to the lower portion 20 of the housing 12. The lower portion 20 of the housing 12 is also provided with a vent 28 to allow air to circulate in the lower portion 20 of the housing 12. Likewise, the upper portion 30 of the housing 12 includes a door 32 provided with a handle 34 and a lock 36 to allow and restrict access to the upper portion 30 of the housing 12. In this example, the door 32 of the upper portion 30 of the housing 12 is provided with an optically transparent pane 38, but this is not required.

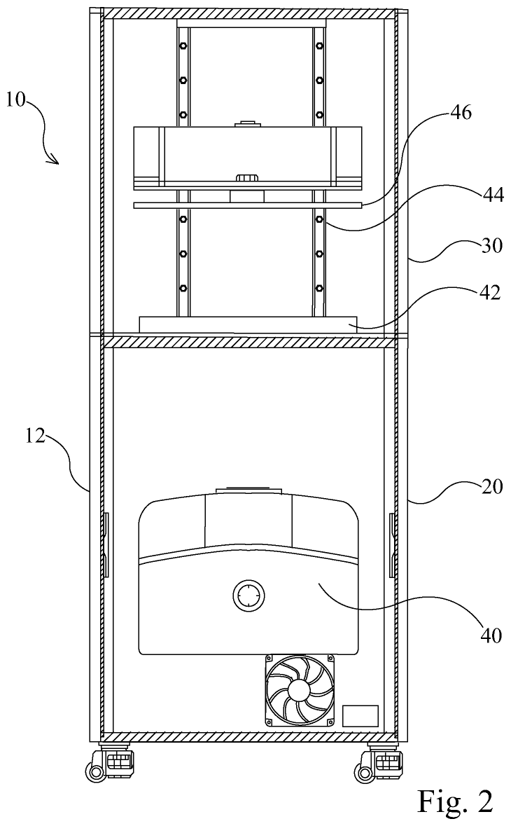

Referring now to FIG. 2, there is an emitting device 40 disposed within the lower portion 20 of the housing 12. The emitting device 40 may be any suitable light-emitting device which may be used to cure or polymerize resin. There is a tank 42 disposed within the upper portion 30 of the housing 12 above the emitting device 40. There is also a linear stage 44 in the upper portion 30 of the housing 12. The linear stage 44 extends vertically away from the tank 42 and a carrier platform 46 is moveable along the linear stage 44. The stereolithography system 10, as thus far described, is a generally conventional stereolithography system used in a three-dimensional printing technique in which cross-sections of an object are formed at a bottom of the object being fabricated.

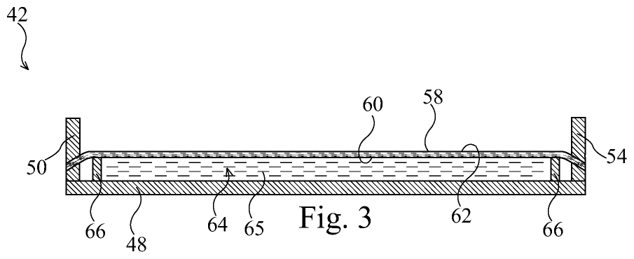

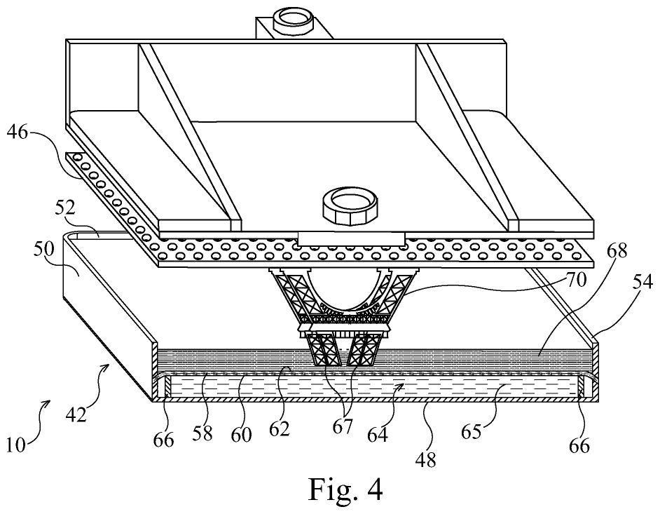

However, as best shown in FIGS. 3 and 4, the tank 42 of the stereolithography system 10 comprises an optically transparent bottom wall 48 and a plurality of side walls, for example, side walls 50, 52 and 54 extending from the bottom wall 48 of the tank 42. There is a membrane 58 disposed within the tank 42 and spaced-apart from the bottom wall 48 of the tank 42. The membrane 58 has a first surface 60 and a second surface 62. The membrane 58 may be a composite membrane made of different materials on the first surface 60 and the second surface 62. The first surface 60 may include a silicone-based polymer, such as polydimethylsiloxane, or a polyolefin polymer such as polyethylene or polypropylene. The membrane 58 and the bottom wall 48 of the tank 42 define a chamber 64 which contains a fluid 65. The fluid 65 may be a liquid such as propylene glycol, silicone oil, glycerol, mineral oil, paraffin oil, water, heavy water or LST Heavy Liquid; a semi-solid gel such as Hydrogel containing (but not limited to) agar, Kappa-Carrageenan, Gellan Gum, sodium alginate, poly(ethylene glycol) dimethacrylate, cellulose and water, Oleo gel containing (but not limited to) ethylcellulose, Kraton™ G styrene-ethylene-propylene (SEP) polymers, styrene-ethylene-butylene-styrene (SEBS) polymers and oils; or a substance having a consistency therebetween such as Silicone putty. The membrane 58 may be supported above the bottom wall 48 of the tank 42 by a support and sealing member 66. The support and sealing member 66 may be a combination of mechanical means that applies and maintains the tension of the membrane 58 while sealing off the fluid 65 in the chamber 64. The membrane 58 may include a fluorinated ethylene propylene or a polytetrafluoroethylene.

In operation, the membrane 58 sits atop the fluid 65 confined within the chamber 64 of the tank 42. As the emitting device 40, shown in FIG. 2, operates, a portion 67 of a thin layer of resin 68 is cured at and proximate to the second surface 62 of the membrane 58, as shown in FIG. 4, to fabricate an object 70 layer by layer with sequential irradiation from the emitting device 40. Since the fluid 65 confined within the chamber 64 is non-compressible, it holds the weight of the membrane 58 and the resin 68, and provides the membrane 58 with a substantially flat surface for fabricating the object 70 while allowing the membrane 58 to flex. The flexing of the membrane 58 allows the object 70 being fabricated to be more easily released from the second surface 62 of the membrane 58, for example, by peeling means or sliding means. By supporting the membrane 58, the fluid 65 reduces the amount of tension needed for the membrane 58 to remain substantially flat during printing. The reduced amount of tension allows the membrane 58 to flex upward with a higher peel angle between the membrane 58 and the object 70 when the carrier platform 46 is moving away from the tank 42. The higher peel angle reduces adhesion forces between the object 70 and the membrane 58 during the printing process. Lower adhesion forces may increase print speeds and delay fatigue failure of the membrane 58. The fluid 65 acts also as a damping medium for the membrane 58 once the object 70 has been released from the membrane 58, which helps to restore the substantially flat surface for the printing process.

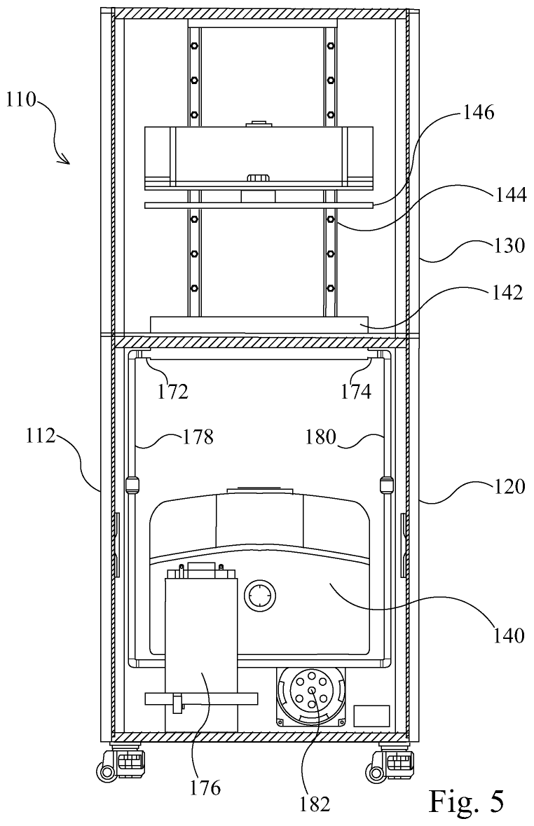

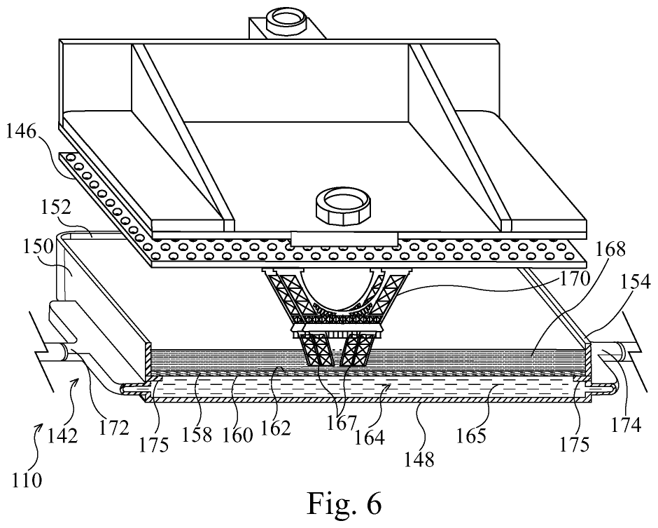

Referring now to FIGS. 5 and 6, there is shown a second embodiment of an improved stereolithography system 110. The stereolithography system 110 shown in FIGS. 5 and 6 is generally similar to the stereolithography system 10, shown in FIGS. 1 to 4, with like parts being given like reference numerals in the 100 series. However, in the stereolithography system 110, a chamber 164 of its tank 142 is in fluid communication with an input port 172 and an output port 174 as shown in FIG. 6. In this example, the membrane 158 is supported by a rib 175 extending along side walls 150, 152 and 154 within the tank 142, but this is not required. The fluid 165 is circulated through the chamber 164 by a pump/reservoir combination 176 shown in FIG. 5. The pump/reservoir combination 176 is in fluid communication with the input port 172 via an input conduit 178, and the output port 174 is in fluid communication with the pump/reservoir combination 176 via an output conduit 180. It will be understood by a person skilled in the art that, in other examples, the pump and reservoir may be separate components. The pump/reservoir combination 176 may also function to aerate the fluid 165, shown in FIG. 6, for example, by mechanical aeration, diffusion aeration, or a combination thereof. There may be a heat exchanger 182 to heat and/or cool the fluid 165 to allow for a more controlled printing environment and reduced viscosity of the resin 168.

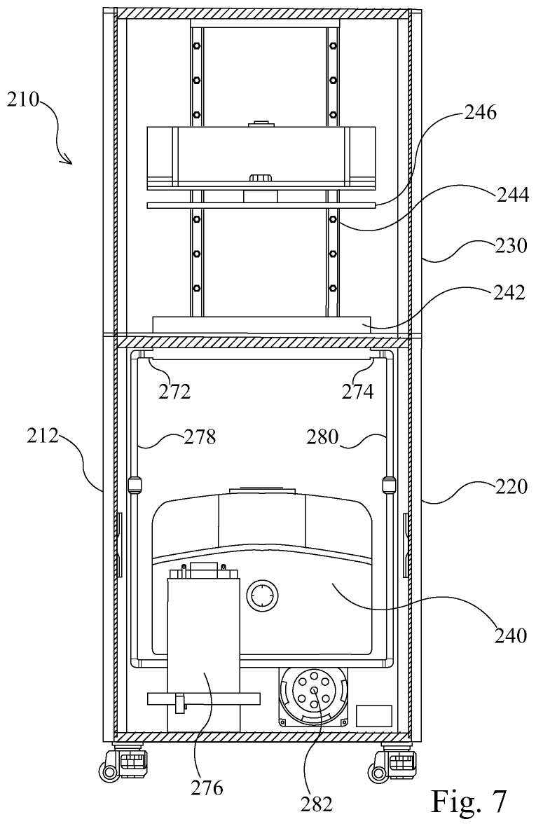

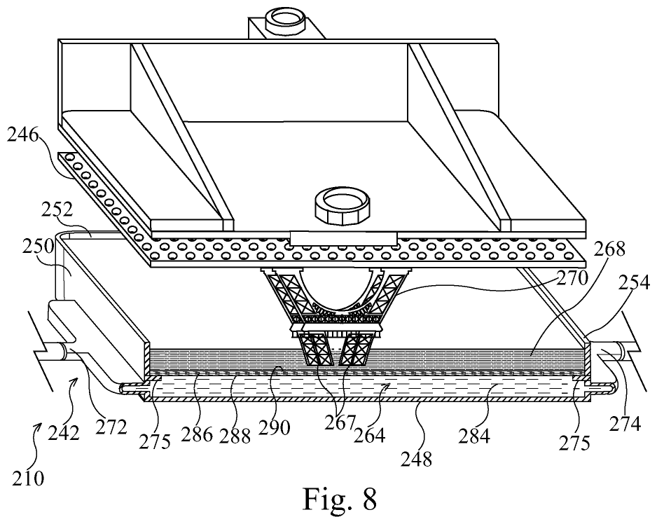

A third embodiment of an improved stereolithography system 210 is shown in FIGS. 7 and 8. The stereolithography system 210 shown in FIGS. 7 and 8 is generally similar to the stereolithography system 110, shown in FIGS. 5 and 6, with like parts being given like reference numerals in the 200 series. However, in the stereolithography system 210, a chamber 264 of its tank 242 is filled with an oxygenated fluid 284 and a gas permeable membrane 286 sits atop the oxygenated fluid 284. In operation, oxygen from the oxygenated fluid 284 permeates from a first surface 288 of the gas permeable membrane 286, through the gas permeable membrane 286, to a second surface 290 of the gas permeable membrane 286. The oxygen inhibits curing of resin 268 on the second surface 290 of the gas permeable membrane 286 as an object 270 is being fabricated. Oxygen permeating through the gas permeable membrane 286 inhibits the polymerization of the resin 268, in contact with the second surface 290 of the gas permeable membrane 286, and inhibits the object 270 being fabricated from adhering to the second surface 290 of the gas permeable membrane 286.

The gas permeable membrane 286 may be a polytetrafluoroethylene membrane, such as Teflon® film, or a fluoroplastic membrane, such as a Teflon® AF 1600 film or a Teflon® AF 2400 film, or a polymethylpentene membrane, such as a TPX® film, or a fluorinated ethylene propylene film. The gas permeable membrane 286 may be a composite membrane with different materials on first and second surfaces thereof. For example, the second surface 290 of the gas permeable membrane 286 may be a fluorinated ethylene propylene film or a Teflon® AF 2400 film and the first surface 288 of the gas permeable membrane 286 may be a silicone-based polymer, such as polydimethylsiloxane, or a polyolefin polymer such as polyethylene or polypropylene.

The oxygenated fluid 284 may be water, perfluorocarbon, perfluorodecalin, hydrogen peroxide, propylene glycol, silicone oil, mineral oil, paraffin oil, or any suitable fluid with a high concentration of dissolved oxygen. The oxygenated fluid 284 may also include an oxidizing agent which may increase the concentration of dissolved oxygen in the oxygenated fluid 284. The oxidizing agent may be any suitable oxidizing agent such as calcium peroxide or potassium permanganate. The oxidizing agent oxygenates the oxygenated fluid 284 via a chemical reaction.

In other examples, it may not be necessary to use an oxygenated fluid or a gas permeable membrane. The fluid may instead be a liquid, and preferably, a liquid having a higher density than the resin. Resins typically have a density of about 1.1 grams/cm³ and a suitable liquid may therefore be an LST Heavy Liquid having a density of about 2.8 grams/cm³ and up to 3.6 grams/cm³. Liquid is non-compressible and provides the membrane with a substantially flat printing surface while allowing the membrane to flex. This allows the object being fabricated to be more easily released from the second surface of the membrane. The liquid should preferably not contain water if a gas permeable membrane is employed as water vapour/moisture may affect the polymerization kinetic of resins. The use of a fluid beneath the membrane is scalable and allows for the use of larger tanks since the membrane is under less tension. The membrane acts as a barrier between the fluid and the resin to reduce interaction between the two, both physically and chemically. Any resin compatible with the membrane may be used.

It will be understood by a person skilled in the art that many of the details provided above are by way of example only, and are not intended to limit the scope of the invention which is to be determined with reference to the following claims.

What is claimed is:

1. A stereolithography system comprising:
an emitting device;
a tank disposed above the emitting device, the tank having an optically transparent bottom wall;
a linear stage extending away from the tank and a carrier platform moveable along the linear stage; and
a membrane disposed within the tank, the membrane having a first surface and a second surface, the membrane and the optically transparent bottom wall of the tank defining a chamber which contains a fluid, wherein the membrane sits atop the fluid and resin sits atop the membrane, and wherein the fluid holds the weight of the membrane and the resin, and provides the membrane with a substantially flat printing surface while allowing the membrane to flex.

2. The stereolithography system of claim 1, wherein the membrane is a composite membrane made of different materials on the first surface and the second surface thereof.

3. The stereolithography system of claim 1, wherein the fluid is a liquid, a semi-solid gel, or a substance having a consistency therebetween.

4. The stereolithography system of claim 1, wherein the fluid is denser than the resin.

5. The stereolithography system of claim 1, wherein the fluid is immiscible with water.

6. The stereolithography system of claim 1, further including a heat exchanger to heat and/or cool the fluid.

7. The stereolithography system of claim 1, further including a pump/reservoir combination in fluid communication with the chamber.

8. A stereolithography system comprising:
an emitting device;
a tank disposed above the emitting device, the tank having an optically transparent bottom wall;
a linear stage extending away from the tank and a carrier platform moveable along the linear stage; and
a gas permeable membrane disposed within the tank, the gas permeable membrane having a first surface and a second surface, the gas permeable membrane and the optically transparent bottom wall of the tank defining a chamber which contains an oxygenated fluid, wherein oxygen from the oxygenated fluid permeates from the first surface of the gas permeable membrane to the second surface of the gas permeable membrane, and the oxygen inhibits curing of resin on the second surface of the gas permeable membrane.

9. The stereolithography system of claim 8, wherein the gas permeable membrane is a fluoroplastic membrane.

10. The stereolithography system of claim 8, wherein the gas permeable membrane is a composite membrane made of different materials on the first surface and the second surface thereof.

11. The stereolithography system of claim 10, wherein the first surface of the gas permeable membrane is a silicone-based polymer.

12. The stereolithography system of claim 11, wherein the silicone-based polymer is polydimethylsiloxane.

13. The stereolithography system of claim 10, wherein the first surface of the gas permeable membrane is a polyolefin polymer.

14. The stereolithography system of claim 13, wherein the polyolefin polymer is polyethylene or polypropylene.

15. The stereolithography system of claim 8, wherein the oxygenated fluid is a liquid, a semi-solid gel, or a substance having a consistency therebetween.

16. The stereolithography system of claim 8, wherein the oxygenated fluid includes propylene glycol.

17. The stereolithography system of claim 8, wherein the oxygenated fluid includes an oil selected from the group consisting of silicone oil, mineral oil and paraffin oil.

18. The stereolithography system of claim 8, wherein the oxygenated fluid includes an oxidizing agent.

19. The stereolithography system of claim 8, further including a heat exchanger to heat and/or cool the oxygenated fluid.

20. The stereolithography system of claim 8, further including a pump/reservoir combination in fluid communication with the chamber.
